(19) United States
(12) Patent Application Publication
(10) Pub. No.: US 2006/0055645 A1
(43) Pub. Date: Mar. 16, 2006

(54) Liquid crystal display and driving method thereof

(76) Inventor: Jong-Seon Kim, Kyungki-do (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/522,007

(22) PCT Filed: Jul. 31, 2003
(86) PCT No.: PCT/KR03/01549

§ 371 Date: Aug. 31, 2005

(30) Foreign Application Priority Data
Aug. 2, 2002 (KR) 10-2002-0045815

(51) Int. Cl. G09G 3/36

(52) U.S. Cl. 345/87

(57) ABSTRACT

An LCD includes a plurality of upper, middle, and lower gate lines transmitting scanning signals provided on upper, middle, and lower areas, respectively, a plurality of pairs of upper and lower data lines transmitting data voltages, and a plurality of pixels connected to the gate lines and the data lines. The pixels are arranged in a matrix and include upper, middle, and lower pixels provided on the upper, the middle, and the lower areas, respectively. Each pair of upper and lower data lines are separated from each other at a disconnection, and the disconnections of the upper and the lower data lines are randomly distributed on the middle area.

### BACKGROUND OF THE INVENION

(a) Field of the Invention

The present invention relates to a liquid crystal display and a driving method thereof.

(b) Description of Related Art

Recent trends of lightness and slimness of personal computers and television sets require lightness and slimness of display devices and thus flat panel displays such as a liquid crystal display (LCD) substitute cathode ray tubes (CRT).

An LCD includes two panels and a liquid crystal (LC) layer with dielectric anisotropy interposed between the two panels. The LCD displays desired images by adjusting electric field applied to the LC layer to control transmittance of light passing through the LC layer.

A typical LCD includes a plurality of the gate lines transmitting scanning signals, a plurality of data lines transmitting data signals, and a plurality of pixels arranged in a matrix and including a plurality of switching elements such as TFTs connected to the gate lines and the data lines.

Scanning signals are sequentially applied to the gate lines to sequentially activate the switching elements connected to the gate lines and data voltages for the pixels connected to the activated switching elements are applied to the data lines. The data voltages are then applied to the pixels via the activated switching elements. All the gate lines are once scanned to make all the pixels be supplied with the data voltages in a frame.

Since the duration for one frame is fixed, for example, by one sixtieth seconds, higher resolution of LCDs, which requires more gate lines, reduces the scanning time for each gate line to yield insufficient application time of the data voltages and thus to deteriorate image quality.

A technique called “dual scan” is recently suggested for obtaining sufficient scanning time, which separately drives upper and lower halves of a display panel divided with respect to an imaginary straight line (referred to as a “disconnection line” hereinafter) parallel to the gate lines. An LCD suitable for the dual scan includes two sets of data lines and gate lines provided in the upper and the lower halves of the panel, respectively, and is provided with a pair of gate drivers and a pair of data drivers. The dual scan simultaneously scans the gate lines in the upper and the lower halves of the panels and thus increases the scanning time twice.

However, a conventional dual scan LCD has a problem that the difference in the luminance between the upper half and the lower half is easily recognized along the disconnection line although the magnitude of the luminance difference is small.

### SUMMARY OF THE INVENTION

A motivation of the present invention is to solve problems of a conventional art.

A liquid crystal display is provided, which includes: a plurality of first second, and third gate lines transmitting scanning signals provided on first, second, and third areas, respectively; a plurality of pairs of first and second data lines transmitting data voltages, each pair of first and second data lines separated from each other at a disconnection and a plurality of pixels connected to the gate lines and the data lines, arranged in a matrix, and including a plurality of first, second, and third pixels provided on the first, the second, and the third areas, respectively, wherein the disconnections of the first and the second data lines are randomly distributed on the second area.

Preferably, one of the first gate lines and one of the third gate lines are simultaneously scanned, and the second gate lines are scanned after the first and the third gate lines are scanned.

Each pair of first and second data lines are preferably supplied with a single data voltage during the scanning of each of the second gate lines.

It is preferable, the number of the first gate lines is equal to the number of the third gate lines, and the second area is disposed between the first area and the third area. The scanning directions for the first, the second, and the third gate lines may be the same.

The liquid crystal display may further include: first and second data drivers applying the data voltages to the first and the second data lines, respectively; a gate driver applying the scanning signals to the first, the second, and the third gate lines; and a memory storing image data corresponding to the data voltages and supplying the image data to the first and the second data drivers.

The image data are written in the memory in synchronization with a write clock and are read in synchronization with a read clock. The read clock preferably has a frequency substantially half of a frequency of the write clock.

Preferably, the image data for the first pixels and the third pixels are supplied to the first data driver and the second data driver, respectively, and the image data for the second pixels are supplied to both the first and the second data drivers.

A method of driving a liquid crystal display including a plurality of first, second, and third gate lines transmitting scanning signals provided on first, second, and third areas, respectively, a plurality of pairs of first and second data lines transmitting data voltages and separated from each other at a plurality of disconnections randomly distributed on the second area, and a plurality of pixels connected to the gate lines and the data lines and including a plurality of first, second, and third pixels provided on the first, the second, and the third areas, respectively, the method includes: sequentially applying scanning signals to the first gate lines and the third gate lines in pairs at the same time; applying data voltages for the first pixels and the third pixels to the first data lines and the second data lines, respectively; sequentially applying scanning signals to the second gate lines; and applying data voltages for the second pixels to both the first and the second data lines.

The application of scanning signals to the second gate lines is preferably performed after the application of scanning signals to the first gate lines and the third gate lines.

The method may further includes: writing image signals corresponding to the data voltages into a memory in synchronization with a write clock; reading out the image signals for the first and the third pixels in synchronization with a read clock preferably having a frequency substantially equal to half of a frequency of the write clock; converting the read-out image signals for the first and the third pixels into the data voltages; reading out the image signals for the second pixels in synchronization with the read clock; and converting the read-out image signals for the second pixels into the data voltages.

### BRIEF DESCRIPTION OF THE DRAWINGS

The above and other advantages of the present invention will become more apparent by describing preferred embodiments thereof in detail with reference to the accompanying drawings in which:

FIG. 1 is a block diagram of an LCD according to an embodiment of the present invention;

FIG. 2 illustrates an exemplary distribution of disconnections in an LCD according to an embodiment of the present invention;

FIG. 3 is a detailed diagram of a portion A shown in FIG. 2;

FIG. 4 is a timing diagram of an LCD according to an embodiment of the present invention; and

FIG. 5 is a schematic diagram of a memory according to an embodiment of the present invention.

### DETAILED DESCRIPTION OF PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

Now, liquid crystal displays and driving methods thereof according to embodiments of the present invention will be described in detail with reference to the accompanying drawings.

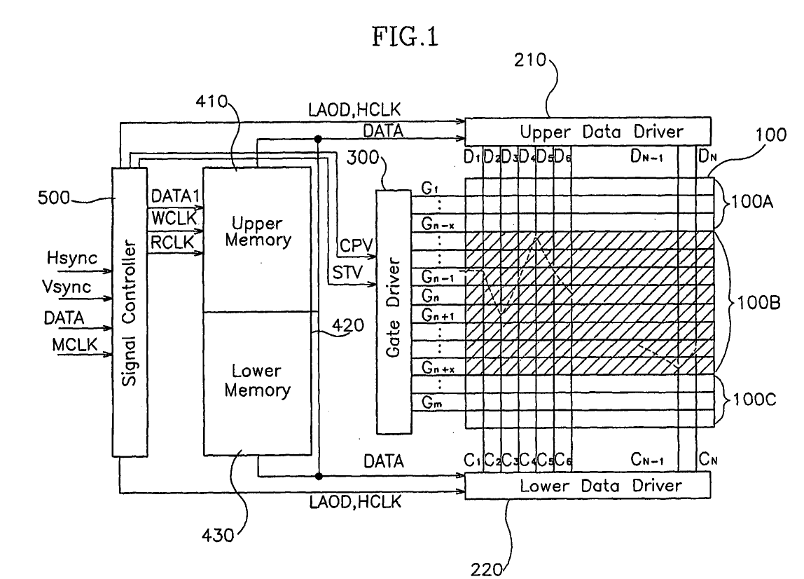

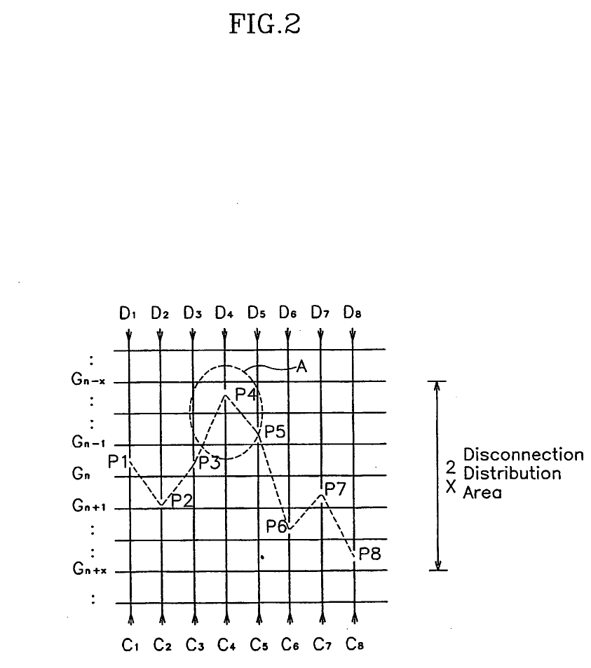

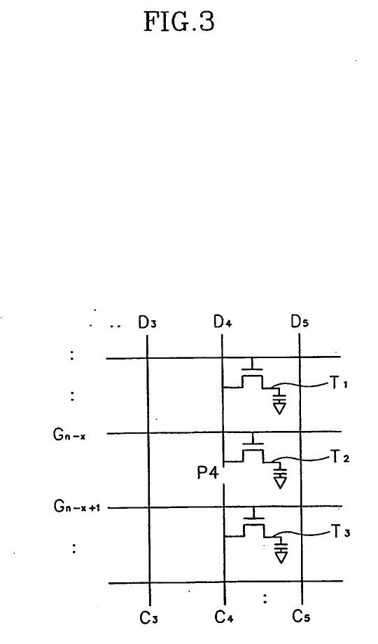

FIG. 1 is a block diagram of an LCD according to an embodiment of the present invention, FIG. 2 illustrates an exemplary distribution of disconnections in an LCD according to an embodiment of the present invention, and FIG. 3 is a detailed diagram of a portion A shown in FIG. 2.

Referring to FIG. 1, an LCD according to an embodiment of the present invention includes a LC panel 100, upper and lower data drivers 210 and 220, a gate driver 300, a memory unit 400, and a signal controller 500.

The LC panel 100 includes a plurality of the gate lines G₁-Gₘ transmitting gate signals (also referred to as scanning signals), a plurality of upper and lower data lines D₁-D_{N} and C₁-C_{N} transmitting data voltages, and a plurality of pixels connected to the gate lines G₁-Gₘ and the data lines D₁-D_{N} and C₁-C_{N}.

Referring to FIG. 3, each pixel includes a LC capacitor C_{LC} and a thin film transistor Tᵢ (i=1, 2, . . . ) connected thereto. The LC capacitor C_{LC} includes a pixel electrode (not shown), a common electrode (not shown), and a LC layer (not shown) interposed therebetween, and a thin film transistor Tᵢ (i=1, 2, . . . ) has a gate connected to one of the gate lines G₁-Gₘ, a source connected to one of the data lines Dᵢ-D_{N} and C₁-C_{N}, and a drain connected to the pixel electrode of the LC capacitor C_{LC}.

The gate lines G₁-Gₘ are grouped into an upper set including a plurality of gate lines G₁-Gₙ₋ₓ₋₁, a middle set including a plurality of gate lines Gₙ₋ₓ-Gₙ₊ₓ, and a lower set including a plurality of gate lines Gₙ₊ₓ₊₁-Gₘ (n≠2 m). The areas provided with the upper set, the middle set, and the lower set of gate lines G₁Gₙ₋ₓ₋₁, Gₙ₋ₓ-Gₙ₊ₓ and Gₙ₊ₓ₊₁-Gₘ are referred to as an upper area 100A, a middle area 100B, and a lower area 100C, respectively.

According to another embodiment of the present invention, the gate lines are grouped into larger than three sets.

The upper data lines D₁-D_{N} and the lower data lines C₁-C_{N} are divided at disconnections Pi (i=1, 2, . . . ) that are randomly distributed on the middle area 100B, as shown in FIG. 2. In other words, the disconnections Pi according to an embodiment of the present invention which separates the upper data lines D₁-D_{N} and the lower data lines C₁-C_{N}, are irregularly distributed on the middle area 100B. For example, a line connecting the disconnections Pi (shown as a dotted line in the figures) is neither straight nor parallel to the gate lines G₁-Gₘ. Instead, the connecting line has a plurality of turning points. This irregular distribution of the disconnections Pi prevent easy detection of brightness difference near the disconnections Pi since human eyes easily recognize regular shapes such as straight lines and flat surfaces even though the brightness difference is very small.

The gate driver 300 is connected to the gate lines G₁-Gₘ and applies a gate-on voltage to the gate lines G₁-Gₘ. According to an embodiment of the present invention, the gate driver 300 sequentially applies the gate-on voltage to the gate lines in pairs among the upper set and the lower set of gate lines G₁-Gₙ₋ₓ₋₁ and Gₙ₊ₓ₊₁-Gₘ, and thereafter, sequentially applies the gate-on voltage to the middle set of gate lines Gₙ₋ₓ-Gₙ₊ₓ. For example, the gate driver 300 sequentially applies the gate-on voltage to a first gate line G₁, to a second gate line G₂, . . . , and a (n−x−1)-th gate line G₁-Gₙ₋ₓ₋₁ of the upper set of gate line G₁-Gₙ₋ₓ₋₁ in a downward direction, and, at the same time, the gate driver 300 sequentially applies the gate-on voltage to a first gate line Gₙ₊ₓ₊₁, to a second gate line Gₙ₊ₓ₊₂, . . . , and a final gate line Gₘ of the lower set of gate line Gₙ₊ₓ₊₁-Gₘ in the downward direction. Thereafter, the gate driver 300 sequentially applies the gate-on voltage to a first gate line Gₙ₋ₓ, to a second gate line Gₙ₋ₓ₊₁, . . . , and a final gate line Gₙ₊ₓ of the middle set of gate line Gₙ₋ₓ-Gₙ₊ₓ in the downward direction.

The upper and the lower data drivers 210 and 220 are disposed at the top and bottom of the LC panel 100, respectively, and apply data voltages to the upper data lines D₁-D_{N} and the lower data lines C₁-C_{N}, respectively, based on image signals from the memory unit 400.

The signal controller 500 receives image data DATA, a main clock MCLK, a horizontal synchronization signal Hsync, and a vertical synchronization signal Vsync from an external source, and generates necessary timing signals to be supplied to the memory unit 400, the gate driver 300, and the data drivers 210 and 220.

The memory unit 400 writes and reads image data DATA to be supplied to the upper data driver 210 and the lower data driver 220 in synchronization with a write clock WCLK and a read clock RCLK from the signal controller 500, respectively. The read clock RCLK has a frequency equal to half of the write clock WCLK. Although the memory unit 400 shown in FIG. 1 includes an upper memory and a lower the memory, it may have other configurations.

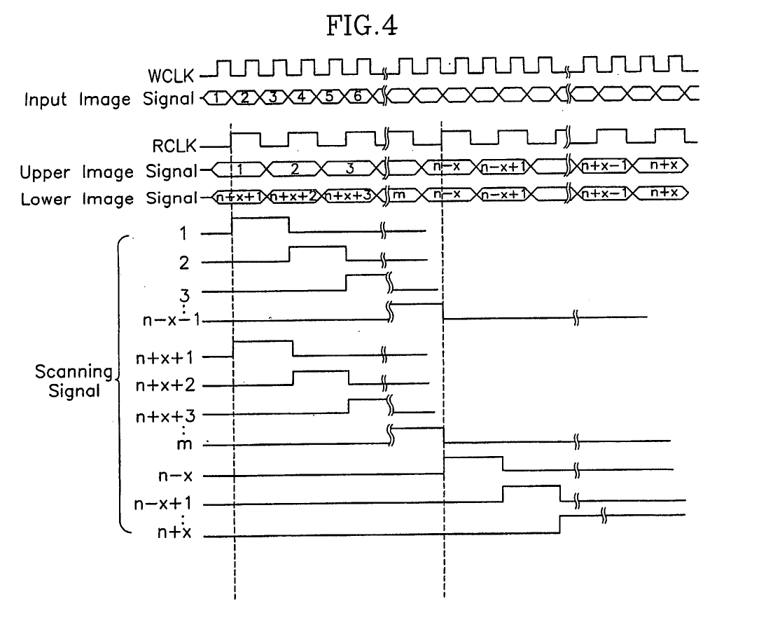

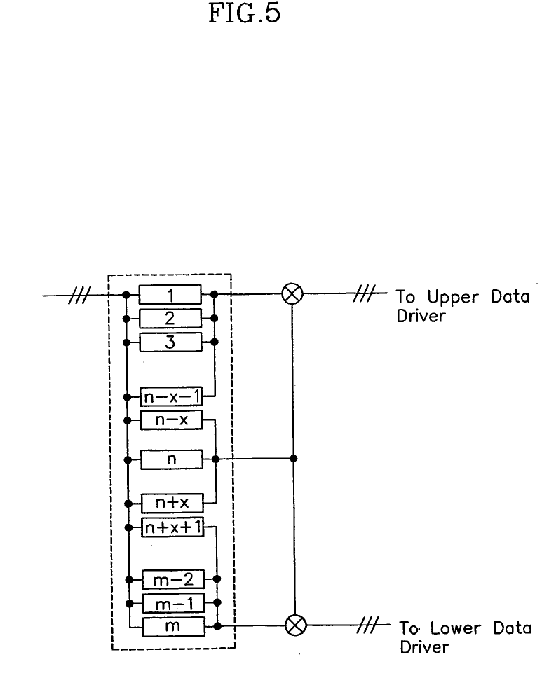

Now, an operation of an LCD according to an embodiment of the present invention is described in detail with reference to FIGS. 4 and 5.

FIG. 4 is a timing chart of an LCD according to an embodiment of the present invention, and FIG. 5 is a schematic diagram of a memory unit.

The signal controller 500 receives image data DATA, a main clock MCLK, a vertical synchronization signal Vsync as a frame synchronization signal, and a horizontal synchronization signal Hsync.

The memory unit 400 writes the image data DATA in synchronization with the write clock WCLK from the signal controller 500. The image data DATA for the pixels in a first row, a second row, . . . , a (n−x−1)-th row, a (n−x)-th row, . . . , a (n+x−1)-th row, a (n+x)-the row, . . . , and a last m-th row are sequentially written in the memory unit 400 in synchronization with a write clock WCLK. The image data DATA for the pixels on the second area 100B may be written into a portion of the upper memory or the lower memory.

The image data DATA stored in the memory unit 400 are read from the memory unit 400 in synchronization with a read clock RCLK and supplied to the upper data driver 210 or the lower data driver 210 and 220.

In detail, the signal controller 500 provides the read clock RCLK for the memory unit 400 such that the stored image data DATA for the pixels in pairs on the upper area 100A and the lower area 100C are read, which in turn are supplied to the upper data driver 210 and the lower data driver 220, respectively. After reading all the image data DATA for the pixels on the upper area 100A and the lower area 100C, the image data DATA for the pixels on the middle area 100B stored in the memory unit 400 are read out to be supplied to both the upper data driver 210 and the lower data driver 220.

The data drivers 210 and 220 receive the image data DATA, which are transmitted in synchronization with a clock HCLK, and convert the received image data DATA into analog data voltages. The upper data driver 210 and the lower data driver 220 apply the data voltages to the upper data lines D₁-D_{N} and the lower data lines C₁C_{N}, respectively, in response to a load signal LOAD from the signal controller 500.

In the meantime, the gate driver 300 applies a gate-on voltage (i.e., high voltage of scanning signals) to one of the upper set of gate lines G₁-Gₙ₋ₓ₋₁ and simultaneously to one of the lower set of gate lines Gₙ₊ₓ₊₁-Gₘ in synchronization with a vertical synchronization start signal STV and a gate clock CPV from the signal controller 500. The application of the gate-on voltage to the gate lines G₁-Gₙ₋ₓ₋₁ and Gₙ₊ₓ₊₁-Gₘ is performed in sequence from the first gate lines G₁ and Gₙ₊ₓ₊₁ to the last gate lines Gₙ₋ₓ₋₁ and Gₘ in a downward direction. Thereafter, the gate driver 300 sequentially applies the gate-on voltage to the middle set of gate lines Gₙ₋ₓ-Gₙ₊ₓ in the downward direction.

The application of the gate-on voltage turn on TFTs connected to the gate lines G₁-Gₘ supplied with the gate-on voltage and the activated TFTs transmit the data voltages from the data drivers 210 and 220 to the pixel electrodes.

Although the data voltages for the pixels on the second area 100B are applied to both the upper data lines D₁-D_{N} and the lower data lines C₁-C_{N}, only one of each pair of the upper and the lower data lines D₁-D_{N} and C₁-C_{N} can transmit a data voltage to a target pixel since each pixel is connected only one of the upper and the lower data lines D₁-D_{N} and C₁-C_{N}.

According to another embodiment of the present invention, the first to the n-th gate lines G₁-Gₙ are sequentially scanned and, at the same time, the (n+x+1)-th to the last gate lines Gₙ₊ₓ₊₁-Gₘ are sequentially scanned. After the scanning of the gate line Gₙ, the (n+1)-th to the (n+x)-th gate lines Gₙ₊1-Gₙ₊ₓ are scanned in sequence.

For this purpose, an LCD according to another embodiment of the present invention includes an upper gate driver (not shown) connected to the first to the n-th gate lines G₁-Gₙ and a lower gate driver (not shown) connected to the (n+1)-th to the m-th gate lines Gₙ₊1-Gₘ, instead of a single gate driver, such that the upper gate driver and the lower gate driver scan the gate lines G₁-Gₙ and Gₙ₊₁-Gₘ, respectively. For example, the upper gate driver sequentially scans from the first gate line G₁ to the n-th gate line Gₙ, while the lower gate driver sequentially scans from the (n+x+1)-th gate line Gₙ₊ₓ₊₁ to the last gate line Gₘ and then scans from the (n+1)-th gate line Gₙ₊₁ to the (n+x)-th gate line Gₙ₊ₓ₊₁ after the scanning of the (n−x)-th to the n-th gate lines Gₙ₋ₓ-Gₙ is finished.

The scanning scheme such as the scanning direction is not limited to those described above, but it can be varied an modified.

As described above, the embodiments of the present invention randomly distribute the disco s between the upper data lines and the lower data lines such that a line connecting the does not exhibit regularity, thereby preventing the brightness difference near the disconnections from being clearly recognized.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A liquid crystal display, comprising;
a plurality of first, second, and third gate lines transmitting scanning signals provided on first, second, and third areas, respectively;
a plurality of pairs of fast and second data lines transmitting data voltages, each pair of first and second data lines separated from each other at a disconnection; and
a plurality of pixels connected to the gate lines and the data lines, arranged in a matrix and including a plurality of first, second, and third pixels provided on the first, the second, and the third areas, respectively,
wherein the disconnections of the first and the second data lines are randomly distributed on the second area.

2. The liquid crystal display of claim 1, wherein one of the first gate lines and one of the third gate lines are simultaneously scanned, and the second gate lines are scanned after the first and the third gate lines are scanned.

3. The liquid crystal display of claim 1, wherein each pair of first and second data lines are supplied with a single data voltage during the scanning of each of the second gate lines.

4. The liquid crystal display of claim 1, wherein the number of the first gate lines is equal to the number of the third gate lines, and the second area is disposed between the first area and the third area.

5. The liquid crystal display of claim 4, wherein the scanning directions for the first, the second, and the third gate lines are the same.

6. The liquid crystal display of claim 1, further comprising:
first and second data drivers applying the data voltages to the first and the second data lines, respectively;
a gate driver applying the sing signals to the first, the second, and the third gate lines; and
a memory storing image data corresponding to the data voltages and supplying the image data to the first and the second data drivers.

7. The liquid crystal display of claim 6, wherein the image data are written in the memory in synchronization with a write clock and are read in synchronization with a read clock having a frequency substantially half of a frequency of the write clock.

8. The liquid crystal display of claim 6, wherein the image data for the first pixels and the third pixels are supplied to the first data driver and the second data driver, respectively, and the image data for the second pixels are supplied to both the first and the second data drivers.

9. The liquid crystal display of claim 8, wherein one of the first gate lines and one of the third gate lines are simultaneously scanned, and the second gate lines are scanned after the first and the third gate lines are scanned.

10. The liquid crystal display of claim 6, wherein the number of the first gate lines is equal to the number of the third gate lines, and the second area is disposed between the first area and the third area.

11. The liquid crystal display of claim 10, wherein the scanning directions for the first, the second, and the third gate lines are the same.

12. A method of driving a liquid crystal display including a plurality of first, second, and third gate lines transmitting scanning signals provided on first, second, and third areas, respectively, a plurality of pairs of first and second data lines transmitting data voltages and separated from each other at a plurality of disconnections randomly distributed on the second area, and a plurality of pixels connected to the gate lines and the data lines and including a plurality of first, second, and third pixels provided on the first the second, and the third areas, respectively, the method comprising:
sequentially applying scanning signals to the first gate lines and the third gate lines in pairs at the same time;
applying data voltages for the first pixels and the third pixels to the first data lines and the second data lines, respectively;
sequentially applying scanning signals to the second gate lines; and
applying data voltages for the second pixels to both the first and the second data lines.

13. The method of claim 12, wherein the application of scanning signals to the second gate lines is performed after the application of scanning signals to the first gate lines and the third gate lines.

14. The method of claim 12, further comprising:
writing image signals corresponding to the data voltages into a memory in synchronization with a write clock;
reading out the image signals for the first and the third pixels in synchronization with a read clock;
converting the read-out image signals for the first and the third pixels into the data voltages;
reading out the image signals for the second pixels in synchronization with the read clock; and
converting the read-out image signals for the second pixels into the data voltages.

15. The method of claim 14, wherein the read clock has a frequency substantially equal to half of a frequency of the write clock.
